(19) United States
(12) Patent Application Publication
(10) Pub. No.: US 2010/0266894 A1
(43) Pub. Date: Oct. 21, 2010

(54) RECHARGEABLE BATTERY HAVING A CURRENT COLLECTING PLATE

(76) Inventors: Sang-Won Byun, Suwon-si (KR); Byung-Kyu Ahn, Suwon-si (KR)

Correspondence Address: CHRISTIE, PARKER & HALE, LLP, PO BOX 7068, PASADENA, CA, 91109-7068, US

(21) Appl. No.: 12/717,935

(22) Filed: Mar. 4, 2010

(30) Foreign Application Priority Data
Apr. 21, 2009 (KR) 10-2009-0034674

(51) Int. Cl. H01M 2/02

(52) U.S. Cl. 429/178

(57) ABSTRACT

Disclosed is a rechargeable battery including an electrode assembly having a positive electrode, a negative electrode, and a separator between the positive and negative electrodes. The electrode assembly has rounded ends and a flat portion between the rounded ends, a case containing the electrode assembly, a cap plate coupled to the case, and a terminal electrically connected to the electrode assembly and exposed to an exterior of the electrode assembly. The battery also includes a current collecting plate electrically connecting one of the positive electrode and the negative electrode to a terminal, and welded to an end of the positive electrode or the negative electrode at the curved portion of the electrode assembly.

### CROSS-REFERENCE TO RELATED APPLICATION

This application claims priority to and the benefit of Korean Patent Application No. 10-2009-0034674 filed in the Korean Intellectual Property Office on Apr. 21, 2009, the entire content of which is incorporated herein by reference.

### BACKGROUND OF THE INVENTION

1. Field

The described technology relates to a rechargeable battery. More particularly, it relates to a rechargeable battery having a current collecting plate.

2. Description of the Related Art

The rechargeable battery is a battery that can be charged and discharged, unlike a primary battery, which is not intended to be recharged. Low-capacity rechargeable batteries have been used for portable small electronic devices, such as mobile phones, laptops computers, and camcorders. Large-capacity batteries have been widely used as power supplies for driving motors, such as a motor for a hybrid car, etc.

Recently, a high power rechargeable battery using a non-aqueous electrolyte having a high energy density has been developed. The high power rechargeable battery is a large-capacity rechargeable battery that includes a plurality of rechargeable batteries connected in series. The high power rechargeable battery may be used in devices requiring a large amount of power, for example, for driving a motor, such as a motor for an electric vehicle, etc.

Further, a large-capacity battery module usually includes a plurality of rechargeable batteries connected in series, wherein the rechargeable battery may be formed in a cylindrical shape, a square shape, etc.

A prismatic-shaped rechargeable battery generally includes an electrode assembly having a positive electrode, a negative electrode, and a separator interposed therebetween. It also may include a case having a space for incorporating the electrode assembly, a cap plate that seals the case and has a terminal hole through which an electrode terminal is inserted. The electrode terminal is electrically connected with the electrode assembly and inserted into the terminal hole to protrude outside of the case.

In a conventional prismatic-shaped rechargeable battery, a lead tab that electrically connects an electrode assembly and a terminal is fixed to a side surface of an uncoated region of the electrode assembly by ultrasonic welding. However, when the lead tab is welded to the entire side surface of the uncoated region of the electrode assembly, the volume of the electrode assembly is unnecessarily increased.

In addition, to allow for ultrasonic welding, the lead tab is generally thin to transmit ultrasonic waves to the uncoated region. However, when the lead tab is thin, its resistance is increased, thereby causing heat generation and output deterioration.

Also, when the rechargeable battery is impacted, contact deterioration may occur between the lead tab and the electrode assembly, which causes internal heat generation and decrease of output.

Furthermore, when the lead tab is welded to a side end of the uncoated region, it may not be stably welded to the uncoated region because the uncoated region is too thin. Particularly, the uncoated region of a lithium ion battery is often thin and weak, making it difficult to adhere and weld the lead tab and the uncoated region.

The above information disclosed in this Background section is only for enhancement of understanding of the background of the described technology and therefore it may contain information that does not form the prior art that is already known in this country to a person of ordinary skill in the art.

### SUMMARY OF THE INVENTION

In embodiments of the present invention, a rechargeable battery may have an electrode assembly that is stably connected to a terminal.

A rechargeable battery according to an exemplary embodiment of the present invention includes: a first electrode, a second electrode, a first electrode uncoated region at an end of the first electrode, a second electrode uncoated region at an end of the second electrode opposite the first electrode uncoated region, and a separator between the first electrode and the second electrode. The electrode assembly may have rounded ends and a flat portion between the rounded ends. A rechargeable battery can include a case containing the electrode assembly, a cap plate combined to the case, and a first terminal electrically connected to the first electrode and at an exterior of the battery. The battery may include a current collecting plate electrically connecting the first electrode and the first terminal, and welded to the first electrode uncoated region at one of the rounded ends of the electrode assembly.

The current collecting plate may have a protrusion that protrudes toward the electrode assembly. The protrusion may be in a semicircle shape.

The current collecting plate may have welding lines where the current collecting plate is welded to the electrode assembly. Each welding line may extend in a radial direction. In addition, the current collecting plate may have a plurality of protrusions, each protrusion being in a radial direction.

An indentation may be opposite and corresponding to the protrusion, and a lead member electrically connecting the first terminal and the current collecting plate may have a lead protrusion in the indentation.

An end of the current collecting plate may be rounded. The current collecting plate may have a supporting rib extending over one of the rounded ends of the electrode assembly. The supporting rib may have an arc-shaped cross-section.

A lead member electrically connecting the terminal and the current collecting plate may include a welding rib welded to the supporting rib. The welding rib may have an arc-shaped cross-section.

The current collecting plate may include a first current collecting portion at a first end of the first electrode uncoated region and a second current collecting portion at a second end of the first electrode uncoated region. The first current collecting portion may be welded to a first rounded end of the first electrode uncoated region and the second current collecting portion may be welded to a second rounded end of the first electrode uncoated region. In addition, the first current collecting portion and the second current collecting portion may be connected by a connection bar.

A lead member electrically connecting the terminal and the current collecting plate may be welded to a center, in a length direction, of the connection bar. An active material of a positive electrode of the electrode assembly may include a lithium compound.

According to an exemplary embodiment of the present invention, the current collecting plate is welded to the first uncoated region at the curved portion of the electrode assembly so that the current collecting plate and the electrode assembly can be more stably welded while the current collecting plate and the first uncoated region are adhered, and accordingly, the terminal and the electrode assembly can be stably connected.

### BRIEF DESCRIPTION OF THE DRAWINGS

FIG. 1 is a perspective view of a rechargeable battery according to a first exemplary embodiment of the present invention.

FIG. 2 is a cross-sectional view of FIG. 1, taken along the line II-II.

FIG. 3 is an exploded perspective view of an electrode assembly and a current collecting plate according to the first exemplary embodiment of the present invention.

FIG. 4 is a side view of the current collecting plate welded to the electrode assembly according to the first exemplary embodiment of the present invention.

FIG. 5 is an exploded perspective view of the current collecting plate and a lead member according to the first exemplary embodiment of the present invention.

FIG. 6 is a cut-away perspective view of a current collecting plate and a lead member according to a second exemplary embodiment of the present invention.

FIG. 7 is an exploded perspective view of an electrode assembly and a current collecting plate according to a third exemplary embodiment of the present invention.

FIG. 8 is a perspective view of a current collecting plate and a lead member according to the third exemplary embodiment of the present invention.

### DESCRIPTION OF REFERENCE NUMERALS INDICATING SOME ELEMENTS IN THE DRAWINGS

| | |
|---|---|
| 100: rechargeable battery | 10: electrode assembly |
| 11: positive electrode | 11a: positive electrode uncoated region |
| 12: negative electrode | 12a: negative electrode uncoated region |
| 13: separator | 18: flat portion |
| 19: curved portion | 21, 22: terminal |
| 30: cap plate | 34: case |
| 40, 40′: current collecting plate | 42, 42′: indentation |
| 43, 43′: protrusion | 45, 45′: supporting rib |
| 49: welding line | 50, 50′: lead member |
| 51, 51′: terminal lead unit | 52, 52′: current collecting lead unit |
| 53, 53′: lead protrusion | 73: welding rib |
| 82: upper current collecting unit | 83: lower current collecting unit |
| 85: connection bar | |

### DETAILED DESCRIPTION

Hereinafter, embodiments of the present invention will be described with reference to the accompanying drawings so that those skilled in the art are able to implement it. However, the present invention can be implemented in various ways and is not limited to the following exemplary embodiments. Furthermore, the same reference numbers are used throughout the specification and drawings to refer to the same or like parts.

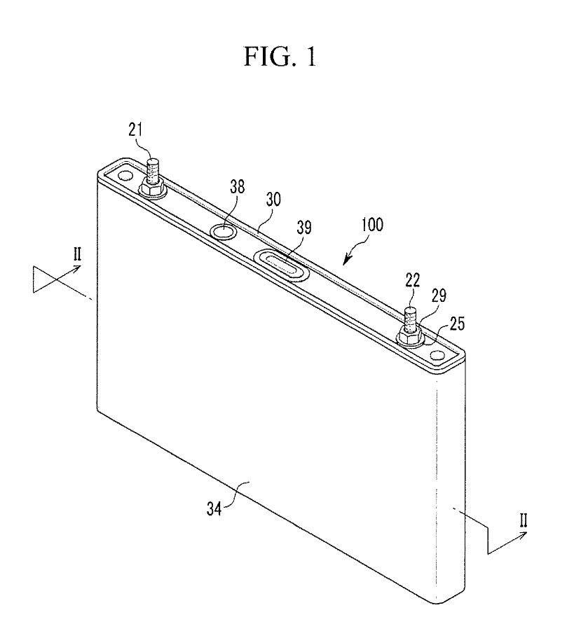

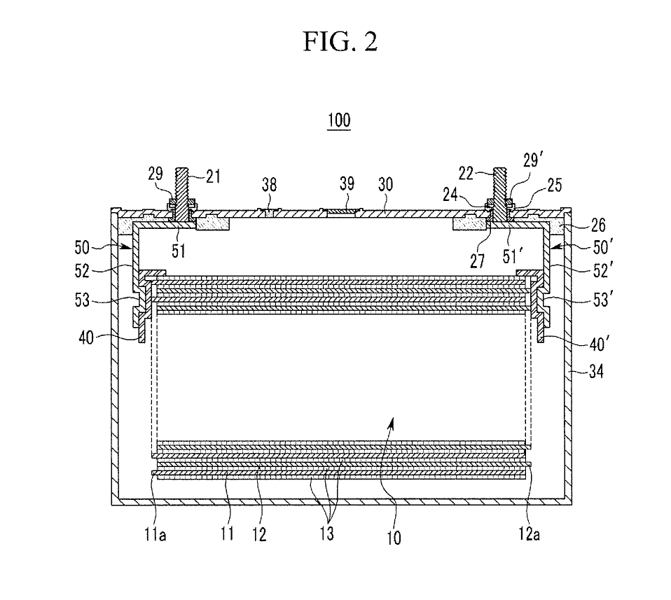

FIG. 1 is a perspective view of a rechargeable battery according to a first exemplary embodiment of the present invention and FIG. 2 is a cross-sectional view of FIG. 1, taken along the line II-II.

Referring to FIG. 1 and FIG. 2, a rechargeable battery 100 according to the first exemplary embodiment includes an electrode assembly 10 wound by placing an insulated separator 13 between a positive electrode 11 and a negative electrode 12, a case 34 to which the electrode assembly 10 is installed, a positive electrode terminal 21 electrically connected to the electrode assembly 10, a negative electrode terminal 22, and a cap plate 30 combined to an opening of the case 34. In some embodiments of the invention, the positive electrode 11 may be referred to as a first electrode or a second electrode and the negative electrode 12 may be referred to as the other of a first electrode or a second electrode. The rechargeable battery 100 according to the first exemplary embodiment is a square-shaped lithium-ion rechargeable battery.

The positive electrode 11 and the negative electrode 12 have bodies formed of a thin plate of metal foil and include coated regions, where an active material is coated, and uncoated regions 11a and 12a, where the active material is not coated. Here, the positive active material may include lithium, and the rechargeable battery according to the present exemplary embodiment is a lithium ion type of rechargeable battery.

The positive electrode uncoated region 11a is at one end of the positive electrode 11 along a length direction of the positive electrode 11, and the negative electrode uncoated region 12a is at the other end of the negative electrode 12 along a length direction of the negative electrode 12. In addition, the separator 13, which is an insulator, is between the positive electrode 11 and the negative electrode 12.

The cap plate 30 is a thin plate. An electrolyte inlet for injection of electrolyte is formed in the cap plate 30 and a sealing cap 38 is installed in the electrolyte inlet once electrolyte is placed in the battery. In addition, a vent member 39, having a groove that can be broken when an internal pressure reaches a predetermined value, is provided in the cap plate 30.

An upper gasket 25 and a lower gasket 27 are provided between the cap plate 30 and the terminals 21 and 22 to insulate the cap plate 30 and the terminals 21 and 22. Here, the terminals include a positive terminal and a negative terminal. In some embodiments of the invention, the positive terminal may be referred to as the first terminal or the second terminal and the negative terminal may be referred to as the other of the first terminal or the second terminal.

The lower gasket 27 is inserted into a terminal hole, and the upper gasket 25 is provided on the cap plate 30. A washer 24 is provided on the upper gasket 25 for buffering fastening force. Nuts 29, 29′ are provided in the positive electrode terminal 21 and the negative electrode terminal 22 for supporting the terminals from the top.

In the positive electrode uncoated region 11a of the electrode assembly 10, the current collecting plate 40 is welded and electrically connected to the positive electrode terminal 21 via the lead member 50. In addition, in the negative electrode uncoated region 12a, a second current collecting plate 40′ is welded and electrically connected to the negative electrode terminal 22 via the lead member 50′. An insulation member 26 is provided between each of the lead members 50, 50′ and the cap plate 30. The lead members 50, 50′ include a terminal lead portion 51, 51′ respectively connected to one of the positive or negative electrode terminals 21 and 22, and current collecting lead portions 52, 52′ attached to respective current collecting plates 40, 40′. And the lead portions 52, 52′ include lead protrusions 53, 53′, respectively.

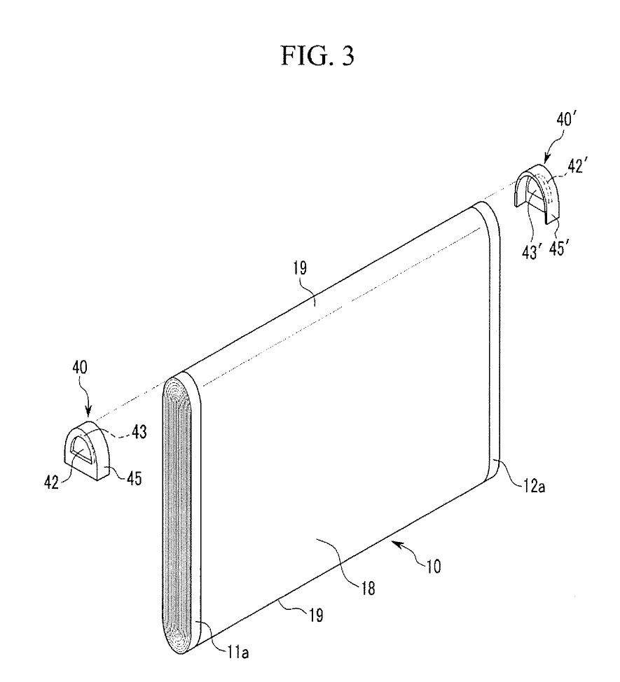

FIG. 3 is an exploded perspective view of the electrode assembly and the current collecting plate according to the first exemplary embodiment of the present invention.

Referring to FIG. 3, the electrode assembly 10 according to the first exemplary embodiment is pressed to be flat in a plate shape while being wound, and accordingly, a flat portion 18, formed in a plate shape, and a curved portion 19, curved at respective ends of the flat portion 18, are formed.

Each current collecting plate 40, 40′ includes an indentation 42, 42′ and a protrusion 43, 43′, closely adhered to the curved portion of the electrode assembly 10. Each protrusion 43, 43′ is then welded to a respective side of the electrode assembly 10. Supporting ribs 45, 45′ protrude out from an edge of each current collecting plate 40, 40′.

In order to correspond to the curved portion 19, an upper portion of each current collecting plate 40, 40′ is rounded and a side end of each current collecting plate 40, 40′ is continued in a straight line from the rounded portion. Each supporting rib 45, 45′ is formed along the rounded portion and the side end connected to the rounded portion. However, each supporting rib 45, 45′ is not formed in a bottom portion of each current collecting plate 40, 40′. Each supporting rib 45, 45′ is then adhered to an external circumferential surface of the electrode assembly 10 when the upper curved portion 19 of the electrode assembly is inserted into each current collecting plate 40, 40′. Accordingly, each supporting rib 45, 45′ supports a current collecting plate 40, 40′ from up, left, and right directions with respect to the electrode assembly 10 so that each current collecting plate 40, 40′ can be installed in an accurate position. In addition, deterioration of contact between each current collecting plate 40, 40′ and respective uncoated regions 11a and 12a due to shaking or vibration can be prevented.

The protrusions 43, 43′ protruding toward the electrode assembly 10 are adhered to respective side end surfaces of the uncoated regions 11a and 12a so as to fix respective protrusions 43, 43′ and the uncoated regions 11a and 12a. Laser welding is then performed while each protrusion 43, 43′ is adhered to the electrode assembly 10. Here, the side end surface indicates a cross-section of the electrode assembly 10 through which the end portions of the stacked uncoated regions 11a and 12a are exposed. The protrusions 43. 43′ have an approximate semicircle shape, having a cross-section formed by a straight line that connects respective ends of an arc.

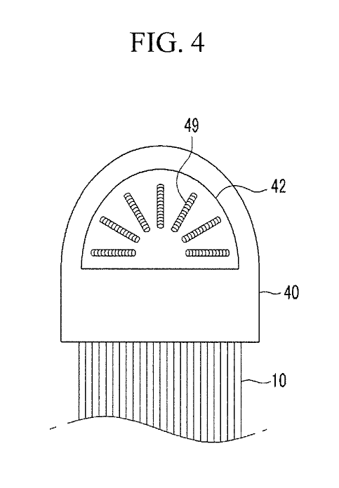

As shown in FIG. 4, the protrusion 43 is adhered to the side end surface, particularly, the curved portion 19 of the electrode assembly 10, and is fixed by laser welding. In this case, a welding line 49, formed in the indentation 42, extends in radial direction that is perpendicular to the direction of the uncoated regions 11a and 12a under the current collector 40. As described, when the welding line 49 is formed in the radial direction, each of the protrusions 43 contacts respective stacked uncoated regions 11a and 12a so that a current can be uniformly output through the protrusions 43. This prevents excessive current from gathering in a central area.

Tension is applied to the uncoated regions 11a and 12a in the curved portion 19, thus, uncoated regions 11a and 12a are densely packed compared to the flat portion 18. Because uncoated regions 11a and 12a are densely packed at the curved portion, they are strong and resistant to bending there. Accordingly, when the protrusions 43 are adhered to the uncoated regions 11a and 12a, deterioration of adhesion due to bending of the uncoated regions 11a and 12a can be prevented. While the protrusions 43 are adhered to the uncoated regions 11a and 12a, the uncoated regions 11a and 12a and the protrusions 43 are stably fixed by laser welding.

At the flat portion 18, the uncoated regions 11a and 12a are not densely aggregated and no structure for supporting in the side direction is provided so that the uncoated regions 11a and 12a and the current collecting plate 40 cannot be easily adhered. Particularly, in case of the lithium rechargeable battery, the uncoated regions 11a and 12a at the flat portion 18 are too thin to sufficiently provide supporting force. Thus, if the uncoated regions 11a and 12a at the flat portion 18 were used to support a current collecting plate, a structure for the aggregation of the uncoated regions 11a and 12a would be required. However, the addition of such an assembly in the case would unnecessarily increase the volume of the electrode assembly, decreasing the power output per unit volume.

However, according to the present exemplary embodiment, the uncoated regions 11a and 12a at the rounded ends can sufficiently support force so that the current collecting plates 40 and the uncoated regions 11a and 12a can be stably combined and the supporting ribs 45 can stably support the current collecting plate 40.

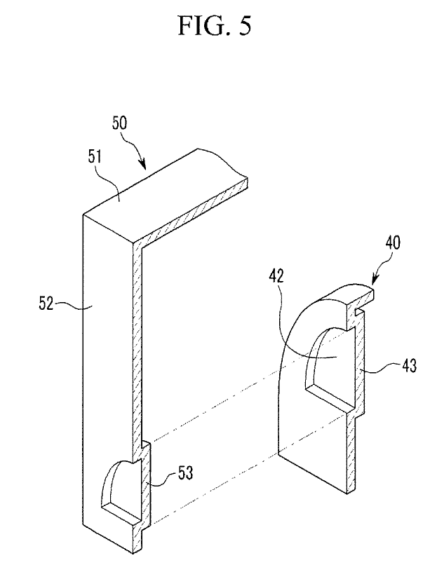

FIG. 5 is an exploded perspective view of the current collecting plate and the lead member according to the first exemplary embodiment of the present invention.

Referring to FIG. 5, the lead member 50 according to the present exemplary embodiment includes a terminal lead portion 51 connected to the terminal, a current collecting lead portion 52 attached to the lead portion 51 and the current collecting plate 40, and a lead protrusion inserted in an indentation 42 at an external side surface of the current collecting plate 40. The protrusion 43 extends toward the current collecting plate 40 so that the indentation 42 is formed at an opposite side of the protrusion 43.

The lead protrusion 53 is approximately a semicircle shape corresponding to the indentation 42, and is welded to the indentation 42 while the lead protrusion 53 is inserted in the indentation 42.

As described, when the lead protrusion 53 is combined with the indentation 42 of the current collecting plate 40 by being inserted therein, contact deterioration of the lead member 50 and the current collecting plate 40 due to external vibration or impact can be prevented.

With the above-described structure, a current collected at the uncoated regions 11a and 12a can be transmitted to the terminals 21 and 22 through the current collecting plates 40 and the lead members 50.

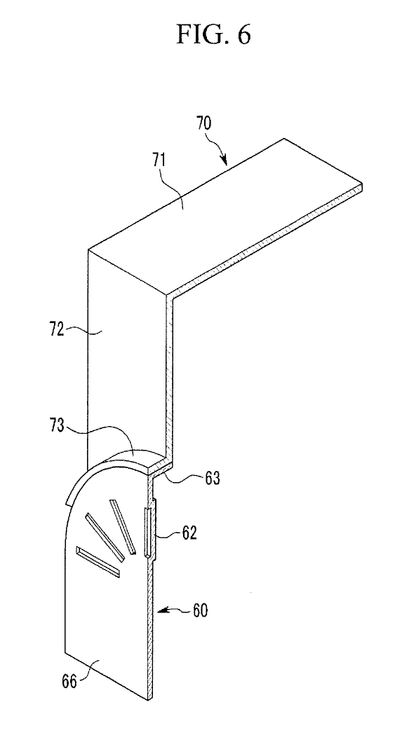

FIG. 6 is a cut-away perspective view of a current collecting plate and a lead member of a rechargeable battery according to a second exemplary embodiment of the present invention.

Referring to FIG. 6, a rechargeable battery 6 according to the second exemplary embodiment of the present invention has the same structure as that of the rechargeable battery according to the first exemplary embodiment except for the structures of a current collecting plate 60 and a lead member 70. Description of the structures which are the same will be omitted.

A current collecting plate 60 according to the present exemplary embodiment includes a plate portion 66 adhered to a side surface of an electrode assembly 10, and a supporting rib 63 extending from the side and upper ends of the plate portion 66.

An upper portion of the plate portion 66 is rounded. A plurality of protrusions 62 are elongated in a radial direction and formed consecutively along a periphery at the upper portion of the plate portion 66. The upper portion of the plate portion 66 is adhered to the curved portion 19 of the electrode assembly 10. The supporting rib 63 is adhered to an external circumference of the curved portion 19 to support the current collecting plate 60.

Each of the protrusions 62 is in a radial direction, and is perpendicular to the respective uncoated regions 11a or 12a under the current collecting plate. While each of the current collecting plates 60 are disposed adjacent to respective uncoated regions 11a and 12a, each of the current collecting plates 60 and respective uncoated regions 11a and 12a are welded by irradiating a laser the length direction of the protrusions 62.

In other words, in this case, the protrusion 62 presses respective uncoated regions 11a or 12a to maintain surface contact with the underlying uncoated regions 11a or 12a, and each current collecting plate 60 is welded to respective uncoated regions 11a or 12a by irradiating a laser along the length of the protrusions 62.

A lead member 70, welded to the current collecting plate 60, includes a terminal lead portion 71 connected to a terminal, a current collecting lead portion 72 attached to the current collecting plate 60, and a welding rib 73 formed in a lower portion of the current collecting lead portion 72 and attached to the supporting rib 63.

The welding rib 73 has an arc-shaped cross-section, and the shape of the welding rib 73 corresponds to a shape of an upper portion of the supporting rib 63.

Accordingly, the welding rib 73 may be adhered to the top side of the supporting rib 63, and the welding rib 73 and the supporting rib 63 may be welded.

As described, a current path has the shortest distance when the welding rib 73 is joined to the upper end of the supporting rib 63 so that power loss and heat generation can be minimized.

Since current has a characteristic of traveling the shortest distance, the current moves through the shortest distance between the terminal and the uncoated regions. As in the present exemplary embodiment, the current collecting plate 60 is fixed on the upper ends of the uncoated regions 11a and 12a, and the lead member 70 is fixed to the supporting rib 63 at the upper end of the current collecting plate 60 so that the current can move without passing through unnecessary portions. When the distance the current travels is reduced, power loss due to specific resistance of the members can be reduced or minimized and heat generation can be reduced.

In addition, since the welding rib 73 is in contact with the supporting rib 63 over an arc shape, movement to the side direction is mechanically prevented, thus preventing contact deterioration due to vibration in the side direction.

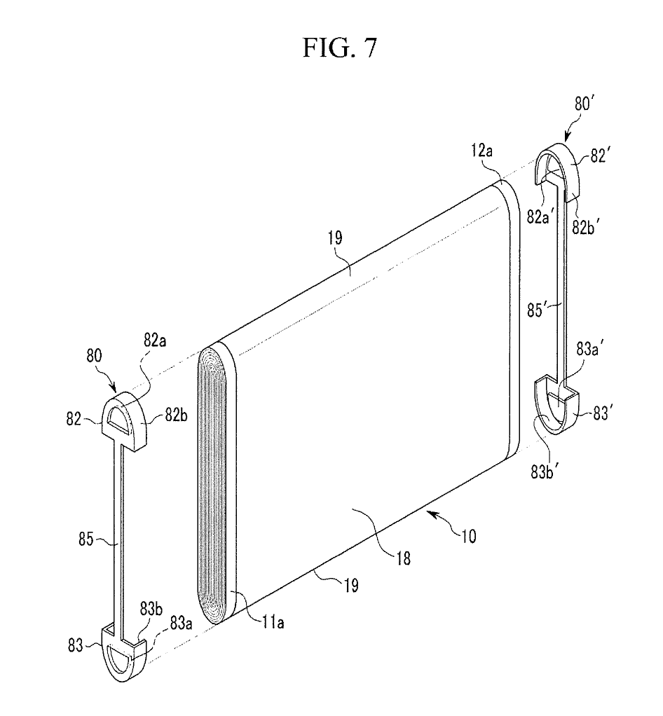

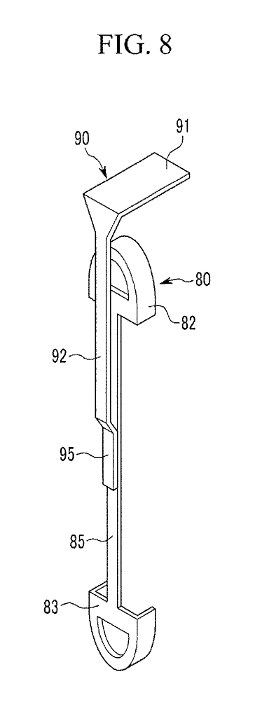

FIG. 7 is an exploded perspective view of an electrode assembly and a current collecting plate according to a third exemplary embodiment of the present invention and FIG. 8 is a perspective view of the current collecting plate and a lead member according to the third exemplary embodiment of the present invention.

Referring to FIG. 7 and FIG. 8, a current collecting plate 80, 80′ according to the present exemplary embodiment includes an upper current collecting portion 82, 82′, a lower current collecting portion 83, 83′, and a connection bar 85, 85′ connecting the upper and lower current collecting portions 82, 82′ and 83, 83′.

The upper current collecting portions 82, 82′ of the current collecting plates 80, 80′ are welded to respective sides of the curved portion 19 at an upper end portion of the electrode assembly 10. The upper current collecting portions 82, 82′ may include a protrusion 82a, 82a′ protruding toward respective uncoated regions 11a and 12a. The upper current collecting portions 82, 82′ may also include supporting ribs 82b, 82b′ at an edge of respective upper current collecting portions 82, 82′ and in contact with respective sides of the external circumference of an upper end portion of the curved portion 19.

Lower current collecting portions 83, 83′ are welded to respective sides of the curved portion 19 at a lower end portion of the electrode assembly 10. The lower current collecting portions 83, 83′ may include a protrusion 83a, 83a′ protruding toward respective uncoated regions 11a and 12a. The lower current collecting portions 83, 83′ may also include supporting ribs 83b, 83b′ at an edge of respective lower current collecting portions 83, 83′ and in contact with respective sides of the external circumference of a lower end portion of the curved portion 19.

The upper end of the upper current collecting portions 82, 82′ and the lower end of the lower current collecting portions 83, 83′ are rounded. In some embodiments of the present invention the upper current collecting portion may be referred to as the first or second current collecting portion and the lower current collecting portion may be referred to as the other of the first or second current collecting portion.

A connection bar 85, 85′ is formed in a square bar shape, and electrically and mechanically connects respective upper current collecting portions 82, 82′ and the lower current collecting portions 83, 83′. As described in the present exemplary embodiment, when the upper current collecting portions 82, 82′ and the lower current collecting portions 83, 83′ are provided, current is collected in the upper and lower ends of the electrode assembly 10 so that centralization of the current at one end of the uncoated regions 11a and 12a can be prevented. In addition, since the upper current collecting portions 82, 82′ and the lower current collecting portions 83, 83′ are connected through respective connection bars 85, 85′, deterioration due to shaking or vibration of the current collection plate 80, 80′ in up and down directions of the electrode assembly 10 can be prevented.

A lead member 90 welded to the current collecting plate 80 includes a terminal lead portion 91 connected to a terminal, a current collecting lead portion 95 attached to the current collecting plate 80, and a connection lead portion 92 connecting the current collecting lead portion 95 and the terminal lead portion 91. The current collecting lead portion 95 is welded to a center, in a length direction, of the connection bar 85, and accordingly, the current collected in the upper current collecting portion 82 and the lower current collecting portion 83 can be uniformly transmitted to the terminal through the lead member 90. When the current collecting lead portion 95 is provided closer to one of the upper and lower collecting portions 82 and 83, much more current can be transmitted through one of the upper and lower collecting portions 82 and 83 due to characteristics of current. However, according to the present exemplary embodiment, the current lead portion 95 is provided in the center portion so that the current can be uniformly transmitted.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery comprising:
an electrode assembly including a first electrode, a second electrode, a first electrode uncoated region at an end of the first electrode, a second electrode uncoated region at an end of the second electrode opposite the first electrode uncoated region, and a separator between the first electrode and the second electrode, the electrode assembly having rounded ends and a flat portion between the rounded ends;
a case containing the electrode assembly;
a cap plate coupled to the case;
a first terminal electrically connected to the first electrode and exposed to an exterior of the battery; and
a first current collecting plate electrically connecting the first electrode and the first terminal, and welded to the first electrode uncoated region at one of the rounded ends of the electrode assembly.

2. The rechargeable battery of claim 1, wherein the first current collecting plate has a protrusion that protrudes toward the first electrode uncoated region.

3. The rechargeable battery of claim 2, wherein the protrusion is in a semicircle shape.

4. The rechargeable battery of claim 2, wherein the protrusion has a plurality of welding lines, each of the welding lines being elongated in a radial direction.

5. The rechargeable battery of claim 2, wherein the first current collecting plate has a plurality of protrusions, each of the protrusions being elongated in a radial direction.

6. The rechargeable battery of claim 2, wherein the first current collecting plate has an indentation opposite and corresponding to the protrusion, and a lead member electrically connecting the first terminal and the first current collecting plate has a lead protrusion in the indentation.

7. The rechargeable battery of claim 1, wherein an end of the first current collecting plate is rounded.

8. The rechargeable battery of claim 1, wherein the first current collecting plate has a supporting rib extending over one of the rounded ends of the electrode assembly.

9. The rechargeable battery of claim 8, wherein the supporting rib is rounded to correspond to one of the rounded ends of the electrode assembly.

10. The rechargeable battery of claim 8, wherein a lead member electrically connecting the first terminal and the first current collecting plate comprises a welding rib welded to the supporting rib.

11. The rechargeable battery of claim 9, wherein a lead member electrically connecting the first terminal and the first current collecting plate comprises a welding rib welded to the supporting rib, and the welding rib is rounded to correspond to the supporting rib.

12. The rechargeable battery of claim 1, wherein the first current collecting plate comprises a first current collecting portion at a first end of the first electrode uncoated region and a second current collecting portion at a second end of the first electrode uncoated region, and the first current collecting portion is welded to a first rounded end of the first electrode uncoated region and the second current collecting portion is welded to a second rounded end of the first electrode uncoated region.

13. The rechargeable battery of claim 12, wherein the first current collecting portion and the second current collecting portion are connected by a connection bar.

14. The rechargeable battery of claim 13, wherein a lead member electrically connecting the first terminal and the first current collecting plate is welded to a center, in a length direction, of the connection bar.

15. The rechargeable battery of claim 1, wherein an active material of a positive electrode of the electrode assembly includes a lithium compound.

16. The rechargeable battery of claim 1, wherein the first current collecting plate is attached to the first electrode uncoated region by laser welding.

17. The rechargeable battery of claim 1, further comprising a second current collecting plate electrically connecting the second electrode and a second terminal.
